(19) United States
(12) Patent Application Publication
(10) Pub. No.: US 2026/0094515 A1
(43) Pub. Date: Apr. 2, 2026

(54) SYSTEM AND METHOD FOR LOWERING EMS RESPONSE TIMES

(71) Applicant: Dani Hatch, Riverside, MO (US)

(72) Inventor: Dani Hatch, Riverside, MO (US)

(21) Appl. No.: 19/346,037

(22) Filed: Sep. 30, 2025

Related U.S. Application Data
(60) Provisional application No. 63/701,776, filed on Oct. 1, 2024.

(51) Int. Cl. G08B 25/00; G08B 21/02; G08B 25/10

(52) U.S. Cl. CPC G08B 25/006; G08B 21/02; G08B 25/10

(57) ABSTRACT

The present disclosure relates generally to an emergency response coordinator system, which requests engagement of one or more emergency services to assist a user. The emergency response coordinator system communicates with the one or more emergency services and provides a location of the user to the one or more emergency services. The emergency response coordinator system sends an alert to pre-determined individuals associated with the user and presents a video related to a type of emergency to the user. The emergency response coordinator system sends video and audio data associated with the user to the one or more emergency services and sends one or more commands to a hardware device associated with the dwelling of the user.

### TECHNICAL FIELD

The present disclosure relates generally to systems and methods for reducing EMS response times and errors. The present disclosure relates also to the system for coordinating communication between a user and emergency response organizations. The present disclosure relates also to utilizing hardware devices associated with the dwelling of the user to assist emergency response organizations with a timely and accurate response.

### BACKGROUND

There are many challenges and inefficiencies faced by emergency response systems and call centers throughout the United States today. These emergency response systems play a critical role in providing aid to those in critical situations. However, a majority of the emergency response systems are outdated, and the information provided to first responders can be inaccurate, delayed, or undeliverable. Most of the Public Safety Answering Point (PSAP's) serving these emergency response systems are understaffed and overburdened with non-emergency calls.

That is, the current standard of EMS response and response times are heavily impacted by multiple overlapping factors and ripe to be optimized. While accessibility of PSAPs via landlines and cellphones has improved, calls can be dropped, and it may be difficult for the emergency response organization to determine the location of the caller. The caller may leave out crucial health information or be unable to provide any information while requesting emergency services. An incapacitated person may be completely unable to request emergency services. If the caller lives in a complicated residential area, locating the dwelling of the caller may prove to be difficult in a situation where every moment counts.

There exist organizations directed towards facilitating communication with the PSAPs in a way different from usual contact methods. One example of these organizations is RapidSOS, which serves as an intermediary between application and service vendors and the PSAPs in the United States. While RapidSOS provides efficient and quick access to PSAPs, RapidSOS can only provide the data provided by the software or service vendor, rather than create and categorize its own data based on the user and/or allow the user to manage their own data.

As such, there exists a need for architecture to monitor, assist, and educate users attempting to seek emergency assistance. The architecture would collect and present the data from each user to the intermediaries (i.e., RapidSOS), such that the emergency response organizations are provided with as much information as possible to reduce response times and mistakes made during responses. Furthermore, there is a need for personal hardware devices that interact with the architecture to provide visual assistance to emergency response organizations.

### BRIEF DESCRIPTION OF THE DRAWINGS

The novel features of the disclosure are set forth with particularity in the application. A better understanding of the features and advantages of the present inventive concept will be obtained by reference to the following detailed description that sets forth illustrative examples, in which the principles of the disclosure are utilized, and the accompanying drawings of which:

FIG. 1 illustrates an example of a computing device, in accordance with the present embodiments;

FIG. 2 illustrates an exemplary system for operating an emergency response coordinator system, in accordance with the present embodiments;

FIG. 3 illustrates actor diagram indicating one or more permissions associated with one or more types of users within the emergency response coordinator system, in accordance with the present embodiments;

FIGS. 4A-4L illustrate multiple different exemplary graphical user interfaces (GUI) associated with the emergency response coordinator system, in accordance with the present embodiments;

FIG. 5 illustrates an exemplary household profile, in accordance with the present embodiments;

FIGS. 6A-6B illustrate a hardware device for assisting in emergency service responses, in accordance with the present embodiments;

FIGS. 7A-7C illustrate isometric views of the hardware device of FIGS. 6A-6B, in accordance with the present embodiments;

FIGS. 8A-8G illustrate exemplary graphical user interfaces (GUIs) for an administrator level management application to interact with the emergency response coordinator system, in accordance with the present embodiments; and

FIG. 9 illustrates a method for requesting emergency services using the emergency response coordinator system, in accordance with the present embodiments.

### DETAILED DESCRIPTION

As used herein, the terms “comprises,” “comprising,” “includes,” “including,” “has,” “having” or any other variation thereof, are intended to cover a non-exclusive inclusion. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

### Illustrative Examples of the Disclosure Include

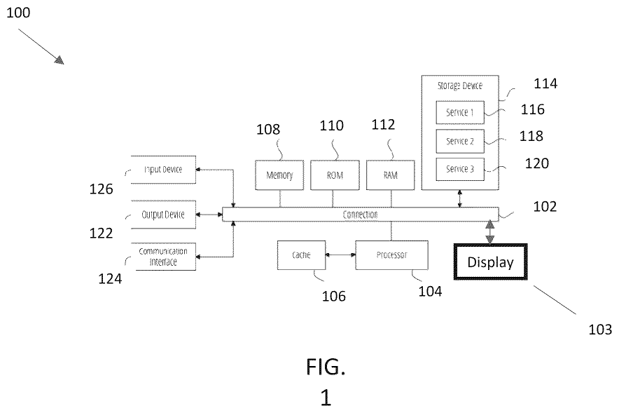

FIG. 1 shows an example of a computing device 100, which can be for example any computing device. Connection 102 can be a physical connection via a bus, or a direct connection into processor 104, such as in a chipset architecture. Connection 102 can also be a virtual connection, networked connection, or logical connection. In other embodiments, a display 103 can be any suitable electronic display to display visual data sent to or generate by the computing device 100.

In some embodiments, computing device 100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing device 100 includes at least one processing unit (CPU or processor) 104 and connection 102 that couples various system components including system memory 108, such as read-only memory (ROM) 110 and random-access memory (RAM) 112 to processor 104. Computing device 100 can include a cache of high-speed memory 108 connected directly with, in close proximity to, or integrated as part of processor 104.

Processor 114 can include any general-purpose processor and a hardware service or software service, such as services 116, 118, and 120 stored in storage device 114, configured to control processor 104 as well as a special-purpose processor where software instructions are incorporated into the actual processor design. Processor 104 may essentially be a completely self-contained computing device, containing multiple cores or processors, a bus, memory controller, cache, etc. A multi-core processor may be symmetric or asymmetric.

To enable user interaction, computing device 100 includes an input device 126, which can represent any number of input mechanisms, such as a microphone for speech, a touch-sensitive screen for gesture or graphical input, keyboard, mouse, motion input, speech, etc. Computing device 100 can also include output device 122, which can be one or more of a number of output mechanisms known to those of skill in the art. In some instances, multimodal systems can enable a user to provide multiple types of input/output to communicate with computing device 100. Computing device 100 can include communication interface 124, which can generally govern and manage the user input and system output. There is no restriction on operating on any particular hardware arrangement, and therefore the basic features here may easily be substituted for improved hardware or firmware arrangements as they are developed.

Storage device 114 can be a non-volatile memory device and can be a hard disk or other type of computer readable media which can store data that are accessible by a computer, such as magnetic cassettes, flash memory cards, solid state memory devices, digital versatile disks, cartridges, random access memories (RAMs), read-only memory (ROM), and/or some combination of these devices, either directly or through an intermediate server.

The storage device 114 can include software services, servers, services, etc. and when the code that defines such software is executed by the processor 104, it causes the system to perform a function. In some embodiments, a hardware service that performs a particular function can include the software component stored in a computer-readable medium in connection with the hardware components, such as processor 104, connection 102, output device 122, etc., to carry out the function.

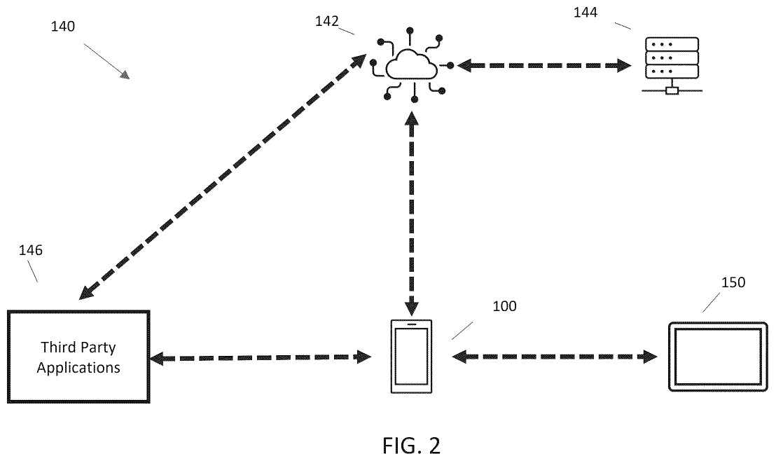

FIG. 2 illustrates an exemplary system 140 for operating an emergency response coordinator system. The system 140 may include the computing device 100, where the computing device 100 may be a mobile device, a tablet, a laptop, a desktop computer, or any suitable electronic device with one or more processors 104. The computing device 100 may be communicatively coupled to a cloud-based server 142, where the cloud-based server 142 may be communicatively coupled with storage 144. The computing device 100 may run an emergency response coordinator application for requesting emergency services and communicate with the cloud-based server 142 that may assist in the requesting of emergency services. In some embodiments, the cloud-based server 142 may run the application for request emergency services, the computing device 100 may run the corresponding companion application, or the cloud-based server 142 or the computing device 100 may run independently of one another.

The computing device 100 and the cloud-based server 142 may each communicate with one or more third-party applications 146. The one or more third-party applications may include one or more emergency response integration services that transmit the emergency requests based on an emergency event and information associated with the emergency requests to the one or more emergency response organizations in a timely fashion. “Emergency event” refers to any situation, condition, or occurrence requiring immediate attention, including medical emergencies, weather related emergencies, natural or environmental emergencies, hazardous material incidents, security or public safety threats, and infrastructure or utility failures. Furthermore, the one or more third party applications 146 may include additional non-emergency service-related organizations, such as food delivery services, commercial product delivery services, property security service, or any service that uses the address of a residence in its services.

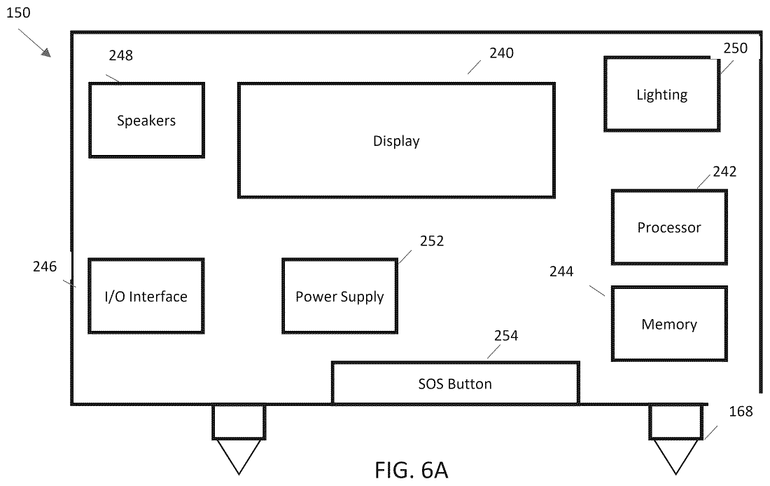

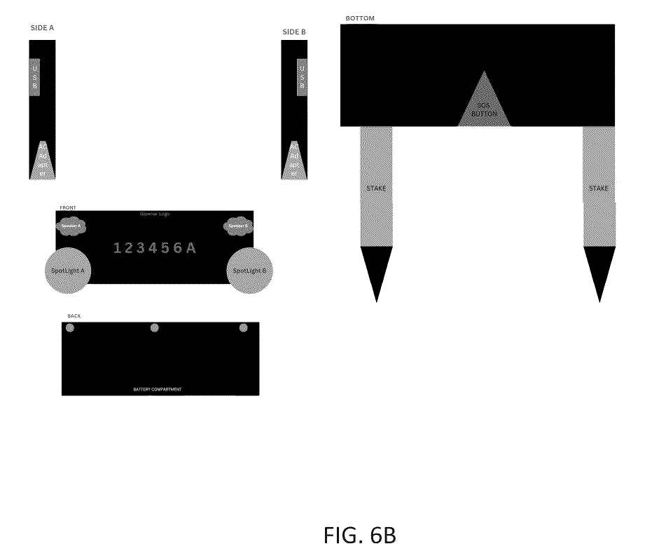

The emergency response coordinator system may synchronize with a hardware device 150 to display various types of information and convey different statuses to physical observers. The hardware device 150 will be described in more detail below in FIG. 6.

The emergency response coordinator system may run on the processor 104 of the computing device 100 and/or on the cloud-based server 142. There is a user centric environment and an administrative centric environment associated with the emergency response coordinator system where each provide different tools to facilitate the operation of the application. Each type of user may have different permissions for the types of tools accessible.

It should be noted that the above-described architecture shown in the exemplary system 140 is merely one exemplary architecture in which various embodiments of the emergency response coordinator system may operate. That is, in some embodiments, each described component, such as the computing device 100, the cloud-based server 142, the storage 144, the one or more third party applications 146, the hardware device 150, may be present or absent depending on the particular architecture of the emergency response coordinator system. Any suitable device among the above-referenced components (i.e., the computing device 100, the cloud-based server 142, the storage 144 the one or more third party applications 146, the hardware device 150) may execute each of the actions described above and herein in relation to the emergency response coordinator system. By way of example, the computing device 100 may handle all processes related to the emergency response coordinator system or select processes while additional components, such as the cloud-based server 142, may handle additional processes in the place of the computing device 100.

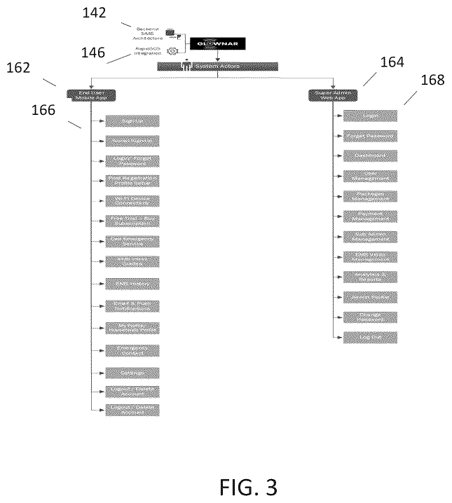

FIG. 3 illustrates an actor diagram 160 indicating one or more permissions associated with one or more types of users within the emergency response coordinator system. Types of users may include a standard user 162, an admin user 164, or both. It should be noted that a particular device may have limited permissions to use certain features. As discussed above, the standard user 162 may have permissions to access and use features 166, while the admin user 164 may have permissions to access and use features 168. In further embodiments, the cloud-based server 142 and/or third-party applications 146 may support each feature. It should be noted that any component described above may facilitate each feature.

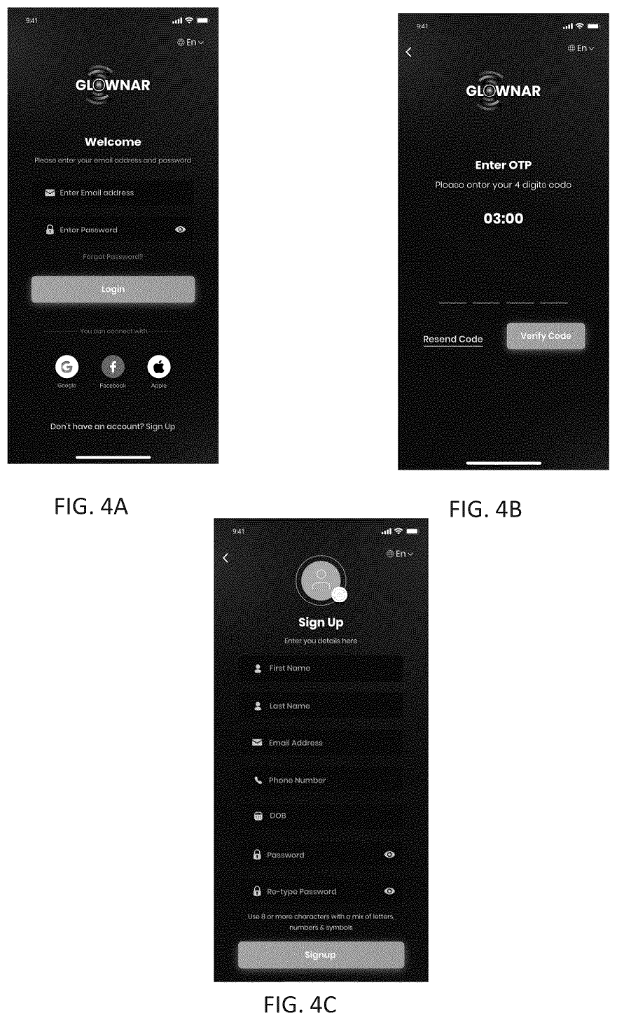

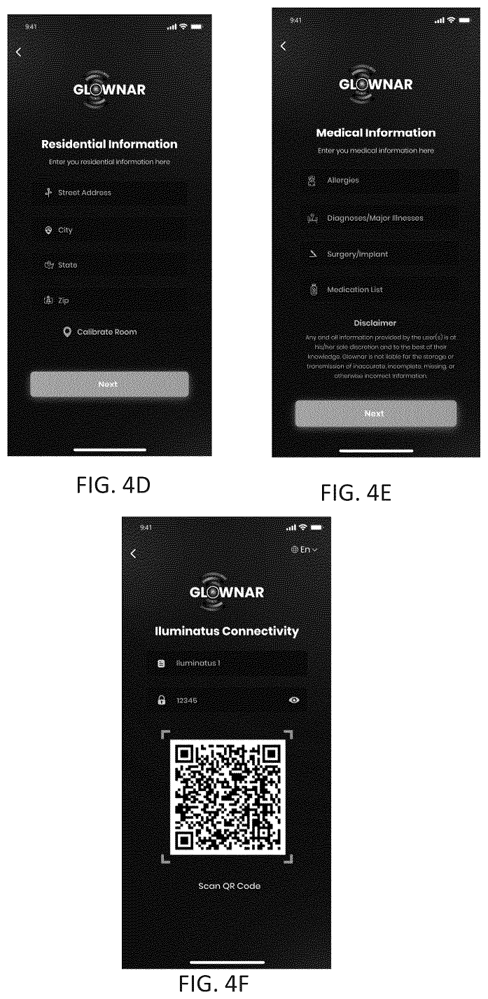

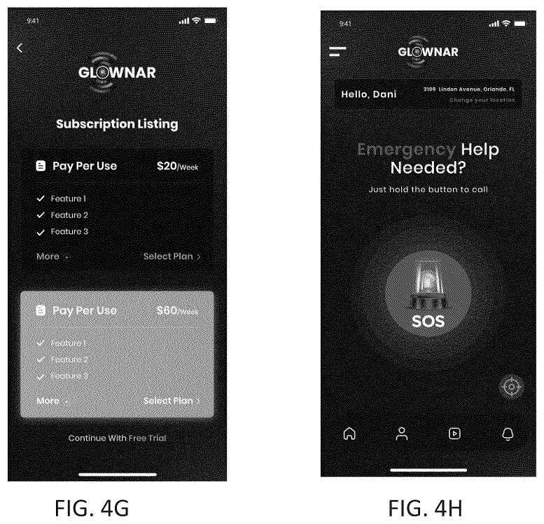

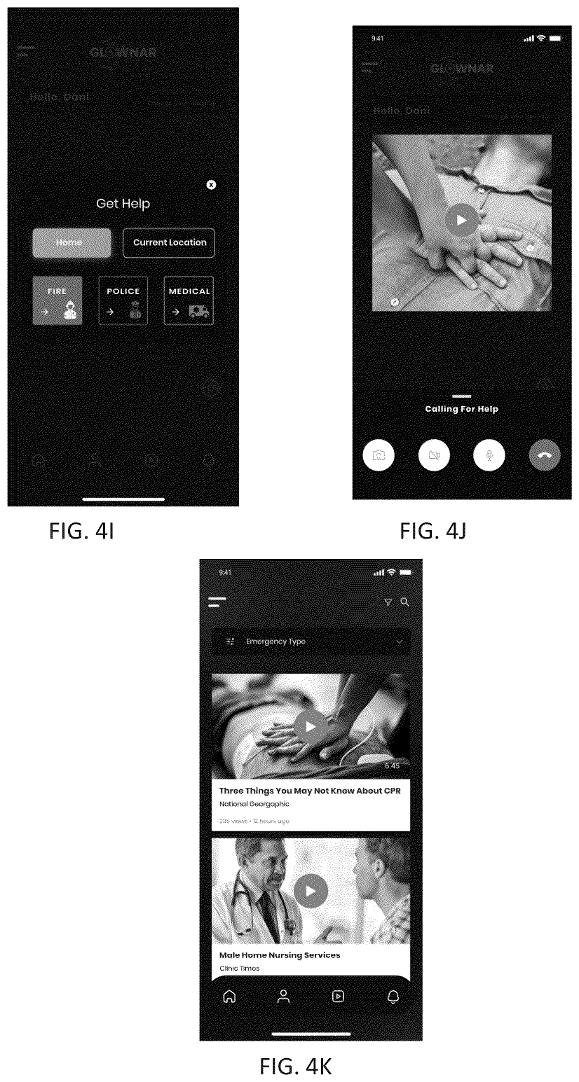

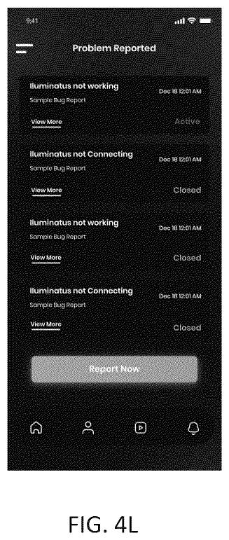

As such, the standard user 162 may use features present within the features 166. Each of these features may have a corresponding graphical user interface (GUI) illustrating the emergency response coordinator system illustrated below in FIGS. 4A-L. In further embodiments, each feature described herein may execute within the emergency response coordinator system, external to the emergency response coordinator system, or both.

With the foregoing in mind, a user sign-up feature within the features 166 may correspond with the GUI illustrated by FIG. 4A. The standard user 162 may register using the user sign-up feature by providing user information in interactive elements of the GUI in FIG. 4A. The user information may include names, birthdates, contact information (e.g., email and/or phone number), and a password for the account. The emergency response coordinator system may verify the information belongs to the standard user by sending a one-time password (OTP) to the provided contact information. In some embodiments, the emergency response coordinator system may verify the information belongs to the standard user associated with the computing device 100. Upon entering the OTP into a corresponding interactive field element in the GUI represented by FIG. 4B, the emergency response coordinator system may indicate that the standard user is verifiably associated with the user information. Additionally, the standard user may use one or more social media accounts or other federated identity services to sign up.

A login feature is illustrated by the GUI in FIG. 4C. The login functionality ensures that registered standard user may login into the application by providing corresponding contact information and password for the account of the standard user (e.g., using email address/phone and password).

A post-registration profile set-up feature is illustrated by the GUIs in FIGS. 4D and 4E. The post-registration profile set-up feature may include inputting user information into the application to associate with the standard user's account, where the user information may include personal, medical, and/or location/residential information associated with the standard user. The user information may include any health conditions, medications, past operations, doctor orders, allergy profiles, and any other relevant health information that may impact professionals to aid the standard user. In one embodiment, the standard user may perform location triangulation within a dwelling associated with the standard user via the emergency response coordinator system to determine residential information and dwelling configuration (e.g., shape of rooms, positioning of rooms, etc.). In some embodiments, the triangulation is performed by the computing device 100, the cloud-based server 142, the one or more third party applications 146, or any combination thereof. In some embodiments, the storage 144, the memory 108, or some combination of each may store the above-referenced information. The emergency response coordinator system may share this information with emergency services or any other relevant organization that is associated with the emergency response coordinator system. In some embodiments, upon the standard user skipping/closing the interface to enter this information, the emergency response coordinator system may save the information that had already been entered. The standard user may update this information at any time.

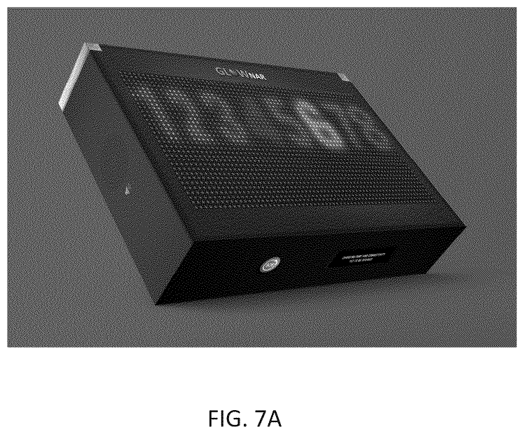

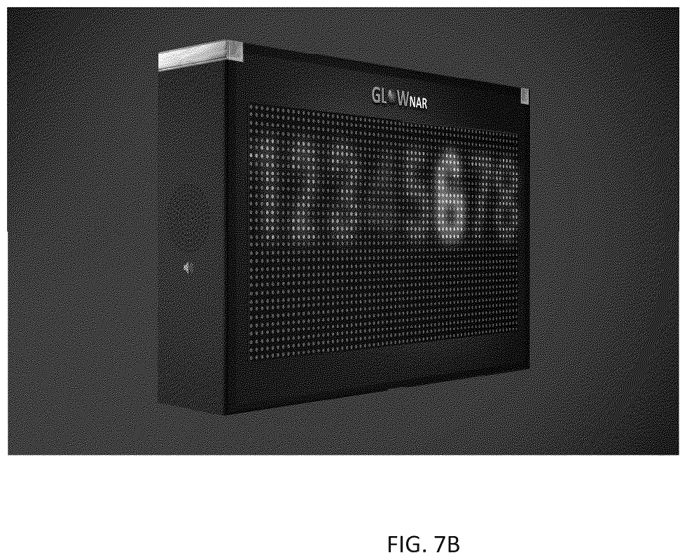

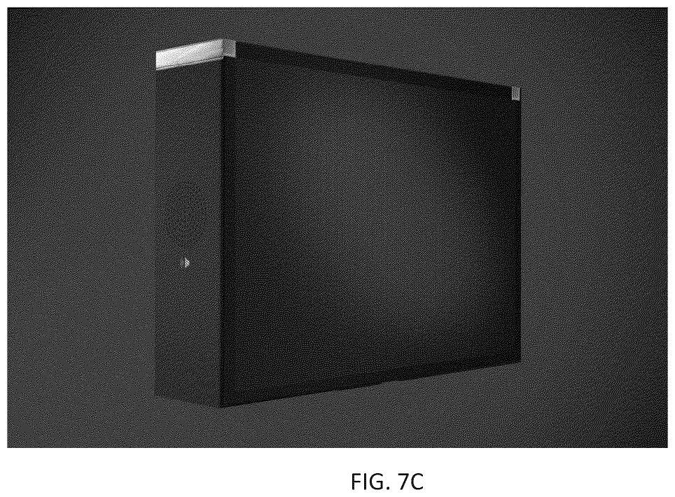

A hardware device connectivity feature is illustrated by the GUI in FIG. 4F. The emergency response coordinator system may connect to the hardware device 150 through a shared Wi-Fi network, Bluetooth, or both. In some embodiments, the computing device 100 may established the connection between the hardware device 150 and the emergency response coordinator system. By way of example, in the event of an emergency, the hardware device 150 may illuminate to be visible to the emergency responders by being disposed outside of the dwelling to ensure speedy identification of the dwelling. The hardware device 150 will be discussed further below in relation to its hardware components and build in FIG. 7.

A subscription dashboard feature is illustrated by the GUI in FIG. 4G. Upon the standard user completing post-registration and connecting to the hardware device 150, the standard may select one subscription package from one or more options. The standard user may view the different types and levels of subscriptions, where each subscription provides different subsets of features at different price options. In some embodiments, a free trial subscription package is presented in each subscription package. The free trial subscription package may be offered for a specific period of time (e.g., 7 days, 14 days, 21 days, etc.) and at the conclusion of the free trial subscription, the standard user may be given the option to automatically renew a currently selected subscription package. In some embodiments, the standard user may enter associated payment info in order to access the free trial subscription package. If the standard user is utilizing specific hardware devices 150, the standard user may be eligible to get a discount on the subscription packages. If the standard user has purchased the subscription package first and then subsequently purchase the specific hardware device 150, then the discount is applicable on the next subscription purchase and/or renewal window.

An emergency request feature is illustrated by the GUI shown in FIG. 4H. Within this feature, when a standard user selects an emergency call option (e.g., a SOS button), the emergency response coordinator system connects the standard user to an emergency response representative/organization and transmits the information associated with the standard user to the emergency response representative/organization. In some embodiments, the emergency response coordinator system may communicate with the one or more third party applications 146 to facilitate connection and data transmission to the emergency response organization. Upon contacting the emergency response representatives, the emergency response coordinator system may present a different GUI, as represented by FIG. 4I, which presents one or more emergency response organizations to contact (e.g., Police, Fire and/or Medical). The standard user may decide between transmitting a current location or a dwelling location to the emergency response organization. In some embodiments, the emergency response coordinator system may use the computing device 100, the cloud-based server 142, the hardware device 150, or any combination thereof to determine the current location of the standard user. If a location is not selected within a particular time threshold, the emergency response coordinator system may automatically send the current location, the dwelling location, or both. The emergency response coordinator system may store response data associated with an arrival of the emergency response organization. That is, the timing, route, and other characteristics of the response by the emergency response organization. In some embodiments, the emergency response coordinator system may present history of past emergency response calls and various analytics determined from the response data. The computing device 100, the cloud-based server 142, and/or the one or more third party applications may determine the emergency organization response analytics and history. In the event that the connection between the standard user (e.g., when the standard user is using the computing device 100) and the emergency response organization is interrupted, the response coordinator system may automatically retrieve the personal, medical, and dwelling information directly from the storage 144. Furthermore, the emergency response coordinator system may attempt to reestablish the connection and/or present an option to the standard user to reconnect. The memory 108 of the computing device 100, the storage 144, or both may store the personal, medical, and dwelling information. That is, the memory 108 and the storage 144 may each store both unique information (e.g., specific to the computing device 100 or the storage 144) and/or duplicated information in any particular arrangement.

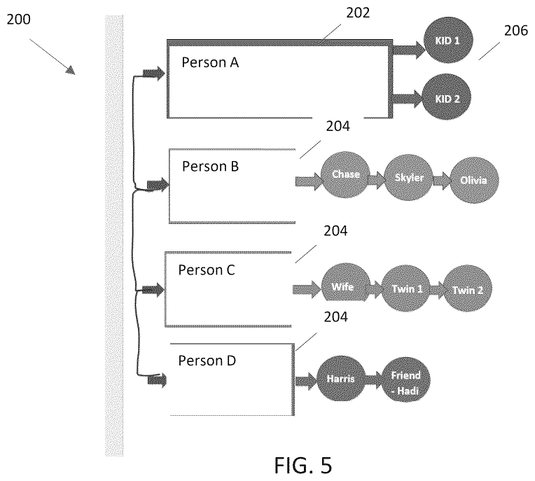

It should be noted that upon requesting emergency assistance, the emergency response coordinator application may automatically notify one or more emergency contacts associated with the user (e.g., family members, partners, etc.). The one or more emergency contacts may include both individuals within a household profile (discussed below in FIG. 5) and/or individuals who are designated solely as emergency contacts and not included in the household profile of FIG. 5. That is, discussion herein of the one or more emergency contacts interaction with the emergency response coordinator application may include a combination of individual emergency contacts and emergency contacts that are also part of the household profile described below. In certain embodiments, specific emergency contacts may be alerted based on a previously determined order of contact and/or which emergency contacts are associated with locations nearby the current and/or dwelling location provided by the standard user. The emergency response coordinator application may present the one or more emergency contacts with one or more videos to ensure that the emergency contacts are able to provide all relevant information and/or assist with the standard user.

In some embodiments, the emergency response feature may automatically trigger based on particular actions occurring to the standard user, around the standard user, and/or around the dwelling of the standard user. That is, the emergency response organization may receive the personal, medical, and dwelling information directly from the emergency response coordinator system upon the occurrence of the particular actions. The particular actions may include, but are not limited to, an alert from a medical device associated with the user, a break-in occurring at the dwelling, a detected falling motion from the user within the dwelling, or any alert associated with the safety and health of the user. In some embodiments, the emergency response coordinator system may transmit an indication of an ongoing emergency based on the particular actions to one or more nearby dwellings and/or the users within those dwellings. The emergency response coordinator system may transmit the indication before, simultaneously, or after communicating with the emergency response organization(s). In some embodiments, the standard user may connect the nearby dwellings and/or users which are an eligible subscriber with a subscription package as described in FIG. 4G. Furthermore, in other embodiments, a machine-readable identification code (e.g., a QR code or standard numerical phrase) may appear on the display of the computing device 100 and without needing to unlock or access the computing device 100.

A video guided response feature is illustrated by the GUI shown in FIG. 4J. Upon requesting an emergency response, the emergency response coordinator application may prompt the standard user to select a category of emergency (e.g., non-emergency or emergency) and/or the type of emergency (e.g., heart attack, drug overdose, break-in, etc.). Based on these selections, the emergency response coordinator application may automatically provide one or more relevant informational videos describing proper procedure for responding to the specific emergency. In some embodiments, as illustrated by the GUI shown in FIG. 4K, a video repository feature is presented to provide the standard user with relevant videos explaining proper procedure without having to request an emergency response. When using the video repository feature, a prompt may appear to the standard user during the watching and/or at the end of the particular video to request the emergency response. Finally, an issue reporting feature is illustrated by the GUI shown in FIG. 4L, where the standard user may report errors with any aspect of the emergency response coordinator application and/or the hardware device 150 and track past error reports.

The one or more emergency contacts discussed above are derived from a household configuration feature and the emergency contact generation feature. That is, the household configuration feature may allow for the standard user to create one or more groups of individuals. The standard user may enter names, photos, and birthdate of each emergency contact in a specific group and the emergency contact's relationship to the standard user.

With the foregoing in mind, FIG. 5 illustrates an exemplary household profile 200. The emergency response coordinator system may create the household profile 200 for the standard user based on one or more inputs received from the standard user. The household profile 200 may include a primary head of household 202 associated with one or more secondary head of households 204. The standard user may associate one or more dependent members 206 with each head of household (202, 204). For example, as illustrated in FIG. 5, Person A is assigned as the primary head of household 202, with two dependents (Kid 1 and Kid 2) associated with Person A. Person B, alternatively, is one of the secondary head of household 204 and is associated with both Person A and the three dependents associated with Person B. The primary head of household 202 may have permissions to modify any of the subsects of the household profile 200, while the secondary head of households 204 may modify each respective dependents list. The emergency response coordinator system may request the standard user to provide contact information for each individual in the household profile 200. In some embodiments, the emergency response coordinator system may automatically add each dependent member 206 and/or each secondary head of household 204 to the emergency contacts discussed herein. In other embodiments, the emergency response coordinator system may exclude specific dependent members 206 (e.g., children) from the emergency contact list automatically or based on one or more instructions from the primary and secondary head of households (202, 204).

Turning to the hardware device 150 and its integration into the system 140, FIG. 6A illustrates a block diagram of the hardware device 150. The hardware device 150 may include a display 240. The display 240 may be a Liquid Crystal Display (LCD) device, an Organic Light Emitting Diode (OLED) display, a Quantum Dot Display, a standard LED display, and the like. The hardware device may include a processor 242 with memory 244. The processor 242 may receive signals via an I/O interface 246. The processor 242 may determine one or more commands to send to a speaker module 248, a lighting module 250, and the display 240 based on the signals via the I/O interface 246. A power supply may provide power to the hardware device 150. In some embodiments, the power supply of the hardware device 150 may use solar panels to provide power to the hardware device 150. The power supply may be associated with the dwelling or an independent power source (e.g., chargeable and/or disposable batteries).

The lighting module 250 may include one or more lighting devices, where the lighting device may include any configurable light source that may change colors based on received inputs and/or pre-existing infrastructure (e.g., LEDs, colored fluorescent bulbs, etc.). In some embodiments, the lighting module 250 is associated with the display 240, partially associated with the display 240, or a separate module from the display 240. That is, the lighting module 240 may utilize one or more lighting devices disposed within the display 240.

The processor 242 may send one or more commands to the lighting module 250 to change a color of the one or more lighting devices based on the category of emergency (e.g., non-emergency or emergency) and/or the type of emergency (e.g., heart attack, drug overdose, etc.). For example, when an emergency is occurring and it is a medical type of emergency, the process 242 may send the one or more commands to illuminate the one or more lighting devices to display red lights. It should be noted that any color or sets of colors may represent any particular category and/or type of emergency (e.g., Police is associated with flashing red and blue, package delivery is associated with a constant green light, a heart attack event is associated with flashing red and green, etc.).

In some embodiments, the processor 242 may send one or more commands to the display 240 and/or the lighting module 250 to display one or more characters (e.g., alphanumerical, symbols, etc.). For example, the processor 242 may send the one or more commands to the display 240 and/or the lighting module 250 to display a numerical address number associated with the dwelling in a specific color.

The hardware device 150 may include an emergency button 254 for immediate requests for emergency responses. The emergency button 154 may be a physical button that is pressed down to activate. One or more physical mounting interfaces may allow for the hardware device 150 to be positioned in different environments around the dwelling/location. That is, the hardware device 150 may be mounted on any applicable surface of the dwelling (e.g., walls, roof, doors, windows, etc.), mounted in the ground on property associated with the dwelling/location (e.g., via a metal/wood stake into the ground), mounted on a physical object associated with the dwelling/location (e.g., a fence, a mailbox, a flagpole, and/or any affixtures located in, on, or outside of the dwelling), or the like.

In some embodiments, two or more hardware devices 150 may communicate with one another to coordinate particular lighting patterns based on the type of service requested, where each hardware device is associated with a distinct dwelling within a defined proximity of one another. The emergency response coordinator system may set the defined proximity to encompass any particular locale (e.g., city limits, neighborhoods, specific measured areas, etc.). By way of example, when an emergency response is requested at a first dwelling with the hardware device 150, the emergency response coordinator system may instruct specific hardware devices 150 at a second dwelling, third dwelling, an entire block, neighborhood, or any combination thereof to illuminate such that a path of light is formed to direct the emergency response organization to the first dwelling. The hardware device 150 may connect to a central actor (i.e., the cloud-based server 142, the computing device 100) to coordinate with each of the hardware devices 150.

One embodiment for a design of the hardware device 150 are illustrated by FIG. 6B, which illustrates physical placement of visible components on the hardware device 150. It should be understood that the placement of the components on/in the hardware device 150 is not limited to the arrangement illustrated by FIG. 6B.

Additionally, an isometric view of the hardware device 150 is illustrated by FIGS. 7A-C. Each of the FIGS. 7A-C illustrate various perspectives of the hardware device 150. As discussed above, each, but not necessarily all, features of the hardware device 150 is illustrated by FIGS. 7A-C.

In alternative embodiments, the hardware device 150 may incorporate simplified lighting modules configured to provide visual indication of an emergency without the need for an integrated display or complex multi-color lighting system. For example, in one embodiment, the hardware device 150 may include a projection light configured to cast a visible light pattern onto a nearby surface (e.g., the ground, wall, or exterior surface of the dwelling). The projection light may emit a single color or a limited set of colors corresponding to particular emergency categories, and in some embodiments may be configured to project simple alphanumeric characters (e.g., house number) images or symbols to assist emergency personnel in locating the dwelling.

In another embodiment, the hardware device 150 may include an even simpler “pin light” configuration. The pin light embodiment may consist of one or more small high-intensity LEDs that illuminate in a constant or flashing pattern based on the type of emergency. For example, the pin light may flash red in the event of a medical emergency or emit a steady blue light to indicate a police emergency. The pin light may be positioned to provide a highly visible beacon while reducing the overall cost and complexity of the hardware device 150.

It should be understood that the projection light embodiment and the pin light embodiment may be deployed individually or in combination with the display 240 and/or the lighting module 250 described above. In all such embodiments, the processor 242 may continue to control the lighting output, whether through projection, pin light, or display-based devices, based on the category and/or type of emergency.

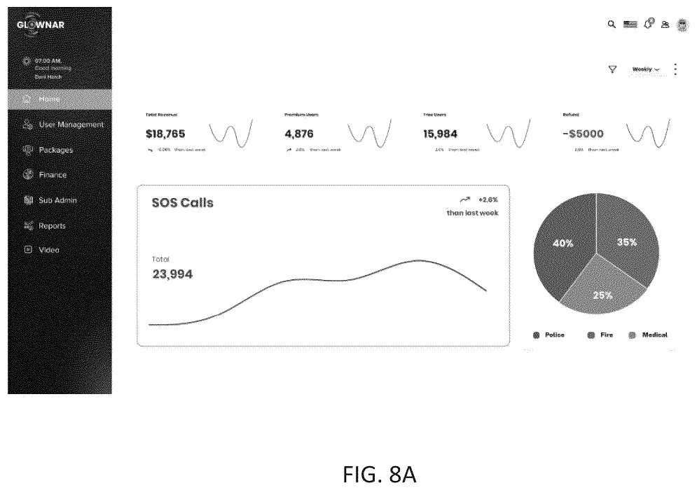

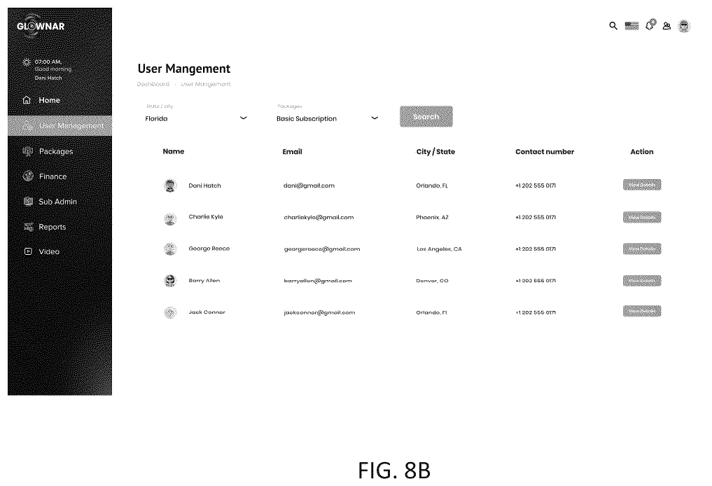

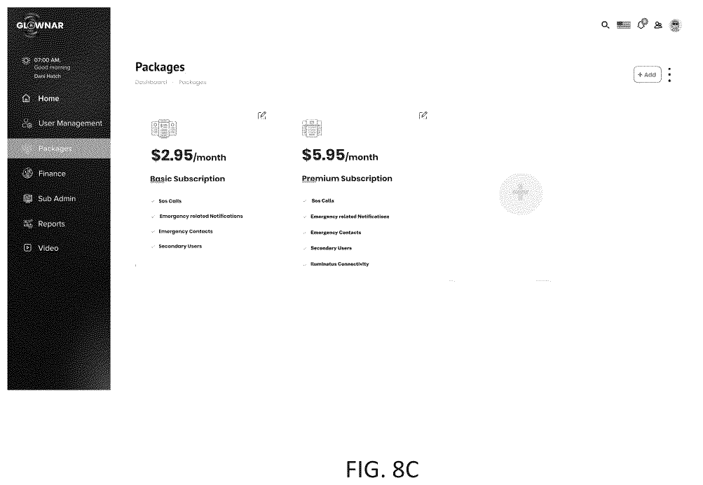

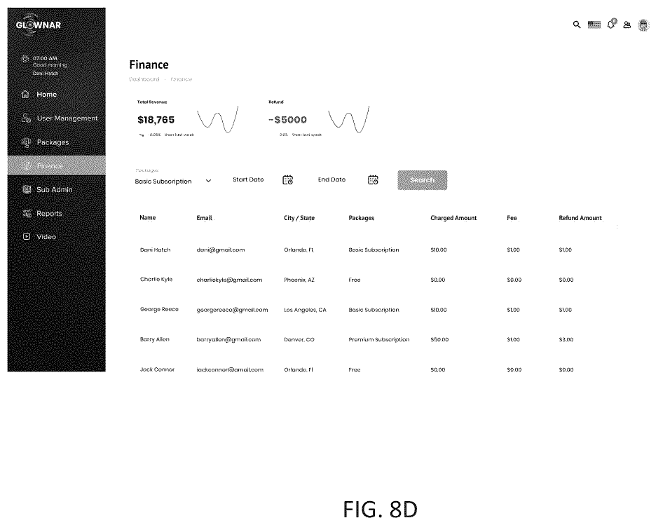

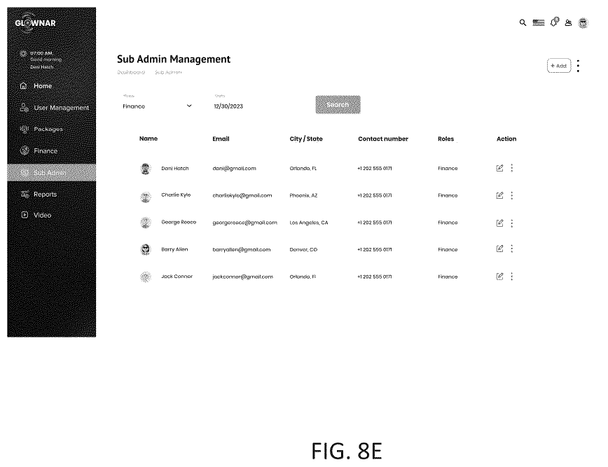

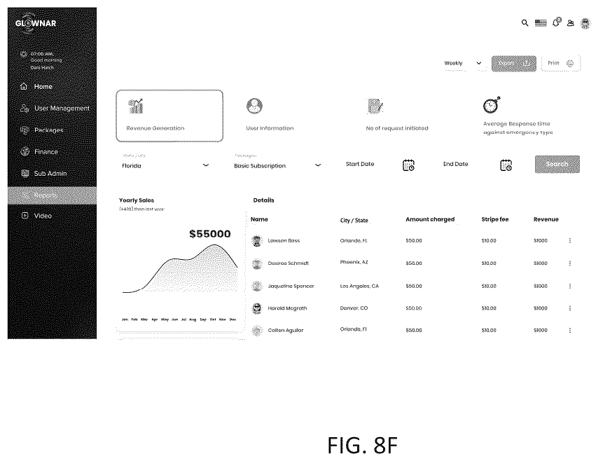

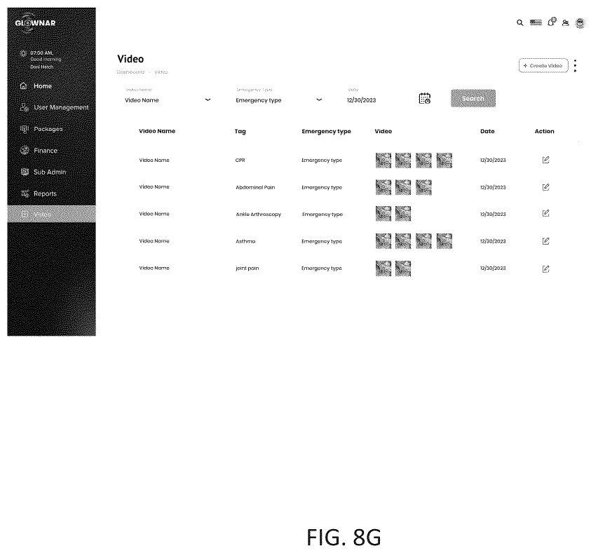

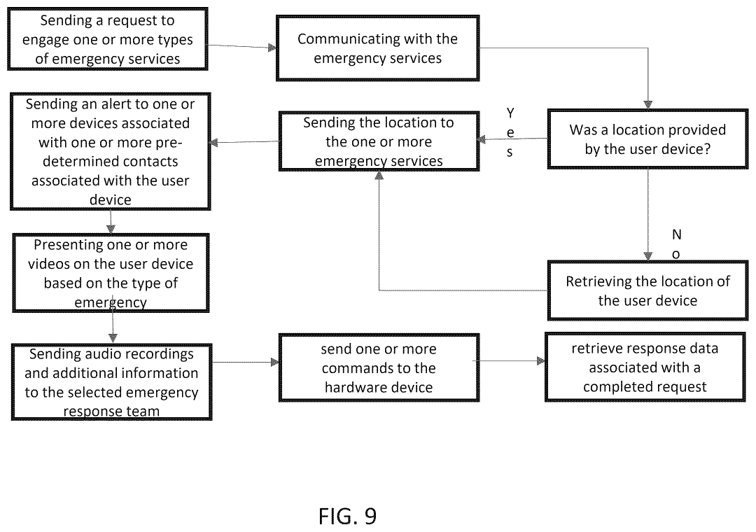

Similar to the tools available to the standard user, an administrative user (herein “admin user”) of the emergency response application system may use a set of administer features to assist the execution of one or more features of the emergency response coordinator system. The admin tools are illustrated in FIG. 3 as the features 168. An admin user may access the features 168. FIGS. 8A-G illustrate exemplary GUIs for an administrator level management application and present exemplary features 168. It should be noted that a singular application may include both the administrator level management application and the emergency response coordinator system. In some embodiments, one or more applications make up each of the administrator level management application and the emergency response coordinator system.

An admin dashboard homepage is illustrated by the GUI shown in FIG. 8A. Upon providing the login info associated with the admin user, the admin user may view different available statistics and access different features of the features 168. The statistics may include total revenue, paid users, free users, emergency call history, automatic call history, and other information that is captured within the emergency response coordinator system.

A user management panel is illustrated by the GUI shown in FIG. 8B. The user management panel may allow the admin user to view and interact with one or more profiles associated with one or more standard users. By selecting a particular profile, the GUI may present the user information and various actions regarding the standard user associated with the particular profile.

A subscription panel is illustrated by the GUI shown in FIG. 8C. The admin user may view the list of subscription packages present in the system and filter through different subscription packages based on one or more criteria. The admin user may create, edit, or disable subscription packages via the GUI in FIG. 8C. When packages are created, edited, or disabled, all standard users receive a notification of the changes being made to each package. In some embodiments, the standard users which are subscribed to a particular package are sent any changes or disabling of the particular package. When the package is disabled, the standard user may be prompted to select a new package.

A financial information panel is illustrated by the GUI shown in FIG. 8D. The financial information panel may allow the admin user to track and view the history of overall payments associated with each subscription package, the entire management application, or any relevant financial information associated with the emergency response coordinator system. A sub-administration management panel is illustrated by the GUI shown in FIG. 8E. The admin user may access the sub-administration management panel to assign particular roles and levels of access to different members of an organization associated with the admin user.

A reporting panel is illustrated by the GUI shown in FIG. 8F. The reporting panel may present analytical insights based on the data that has been collected through the emergency response coordinator system from the standard users and from the emergency response organizations responding to requests from the standard users. These insights may include revenue generation, user information analytics, number of emergency response requests, and response times of emergency response organizations to the requests.

A video configuration panel is illustrated by the GUI shown in FIG. 8G. The admin user may configure one or more videos based on the categories of the emergency present in the emergency response coordinator system. When an emergency response is requested by the standard user, then the one or more videos configured by the admin user are fetched and displayed on the computing device 100. In some embodiments, these videos may be uploaded on the third-party video streaming services (i.e., YouTube) and restricted to viewing only be standard and admin users.

With the foregoing in mind, FIG. 10 illustrates a method 300 for requesting services by the emergency response coordinator system. It should be understood that while the method 300 described herein is executed by the emergency response coordinator system, the steps of the method 300 may be performed in any order and by the processor 104 of the computing device 100, the cloud-based server 142, or any combination thereof. By way of example, the processor 104 may run the emergency response coordinator system and communicate with the cloud-based server 142, the one or more third party applications 146, and/or the hardware device 150 to perform specific tasks. Furthermore, the requested services may include additional non-emergency service-related organizations, such as food delivery services, commercial product delivery services, property security service, or any service that uses the address of a residence in its services. As such, particular steps of the method 300 may be omitted and/or skipped based on the type of service.

At block 302, the emergency response coordinator system may send a request for emergency services to one or more determined emergency response organizations. The emergency response request may include the category of emergency (e.g., non-emergency or emergency) and the type of emergency (e.g., chest pain, stomach pain, etc.). Furthermore, the emergency response may be directed towards a specific type of emergency service (e.g., Police, Fire, Medical). In some embodiments, the emergency response coordinator system may automatically send the emergency response request based at least upon one or more trigger events occurring at and/or around the dwelling associated with the standard user. In other embodiments, the emergency response coordinator system may activate when the emergency response coordinator system receives indication of a voice command. By way of example, when the computing device 100 is running the emergency response coordinator system, the computing device 100 may detect via the input device 126 the voice command to contact the one or more determined emergency response organizations. Additionally, the emergency response coordinator system may send the request for emergency services on behalf of another that is not the standard user, regardless of the proximity of the standard user and the other.

At block 304, the emergency response coordinator system may communicate with the dispatch of the one or more selected emergency response organizations. In some embodiments, the cloud-based server 142 may connect the emergency response coordinator system and the emergency response organization based on the emergency response request. In some embodiments, the processor 104 may directly connect the standard user to the emergency response organization. The emergency response coordinator system may automatically connect to the one or more emergency response organizations based at least upon a status of the emergency and a type of emergency. That is, the emergency response coordinator system may present the status of the emergency and a type of emergency to the emergency response organization such that the emergency response organization is capable of triaging without input from the standard user.

Additionally, in the event that a call between the emergency response coordinator system and the dispatch of the selected emergency response organization is disconnected prior to the conclusion of the call, the emergency response coordinator system may automatically attempt to establish connection with the same dispatch of the selected emergency response organization.

At block 306, the emergency response coordinator system may determine if a location is provided and/or available. It should be noted that this step may occur prior to, following, or during block 304. By way of example, when the standard user is on hold with emergency services, the emergency response coordinator system may determine if the standard user has provided the location. In some embodiments, the one or more trust individuals may receive a notification to provide the location of the standard user prior, during, or following the communication between the emergency response coordinator system and the dispatch. Additionally, the emergency response coordinator system may communicate with the computing device 100, the cloud-based server 142, and/or the hardware device 150 to determine a room and/or area of the dwelling that the standard user is in, such that the emergency services are able to quickly locate the standard user upon the emergency response organization arriving at the dwelling.

When the standard user does not provide the location, at block 308, the emergency response coordinator system may automatically retrieve the location of the standard user. In some embodiments, the location of the standard user and the computing device 100 are similar. In some embodiments, the cloud-based server 142 may attempt to find the location of the computing device 100 by communicating with the processor 104. In some embodiments, if the emergency response coordinator system is unable to communicate the location, the emergency response coordinator system may send the stored residential address and/or last known location associated with the standard user. If the computing device 100 is unable to communicate the location, the cloud-based server 142 may send the stored residential address and/or last known location associated with the standard user. As discussed above, the one or more emergency contacts that have received the notification to provide the location of the standard user may provide the location.

Once the location of the standard user is identified, at block 310 the emergency response coordinator system may send the location to emergency response organization. In some embodiments, the computing device 100 and/or the cloud-based server 142 may send the location to emergency response organization.

At block 312, the emergency response coordinator system sends an alert to one or more devices associated with the one or more emergency contacts associated with the standard user. In some embodiments, the alert may include information representing the location of the standard user, the type of emergency, the type of emergency response organization, and any other relevant information provided by the standard user and/or the emergency response coordinator system. The one or more emergency contacts may provide additional information that is directly sent to the emergency response coordinator system, such as specific medical ailments, treatment options currently available within or nearby the dwelling, and/or any other relevant information about the standard user that has not been yet disclosed. That is, the emergency response coordinator system may automatically transmit the additional information to the emergency response organization.

At block 314, the emergency response coordinator system may present media content items, such as one or more videos, to the standard user based on the type of emergency. As described above in FIGS. 4K, 4L, the one or more videos are curated content that address each compatible type of emergency. The emergency response coordinator system may present the one or more videos to the standard user without the condition of an active call occurring between the emergency response coordinator system and the emergency response organization. In some embodiments, the emergency response coordinator system may automatically play the one or more videos on the display 103 of the computing device 100. In other embodiments, the emergency response coordinator system may play audio associated with the one or more videos without having to display the one or more videos.

At block 316, the emergency response coordinator system may send audio recordings and additional information to the selected emergency response organization. The additional information may include security alerts, nearby incidents that may impact one's health, video recordings, or any other relevant information. That is, the emergency response coordinator system may coordinate with one or more devices within the dwelling (e.g., the computing device 100, the cloud-based server 142, smart devices, security systems, etc.) to retrieve the audio recordings and the additional information and transmit it to the emergency response organization. In some embodiments, the emergency response coordinator system may relay live audio and/or video from the one or more devices inside of, disposed on, and/or exterior to the dwelling to the emergency response organization. For example, a security camera placed on the front of the entrance to the dwelling may provide a live video feed to the emergency response coordinator system, such that the emergency response coordinator system may transmit the live video feed to the emergency response organization.

At block 318, the emergency response coordinator system may send a request representative of the one or more commands to the hardware device 150. The one or more commands may include audio and/or visual feedback to be presented via the hardware device 150. By way of example, the emergency response coordinator system may send a request to the hardware device 150 to illuminate the alphanumerical representation of the dwelling's street address such that it is easily visible. In some embodiments, the hardware device 150 may output a high-volume sound or particular frequency based on the one or more commands. Further, the hardware device 150 may produce live or pre-recorded audio based on the request from the emergency response coordinator system.

At block 320, the emergency response coordinator system may retrieve response data associated a completed request. The response data may include timing data related to response times and call times, types of emergencies, result of the emergency service, received input from the one or more emergency contacts, or any other relevant information associated with the emergency service and the completed request.

It should be noted that the above-described method 300 and additional features described as associated with the emergency response coordinator system may allow for faster response times and provide insight into additional behaviors that assist the relevant organization to respond even quicker. That is, the emergency response coordinator system may present the past calls, routes, events, and other information associated with previous requests to the emergency response organization. Furthermore, the emergency response coordinator system may perform analysis on the recorded data to provide different metrics relating to factors that impact response time. That is, the one or more metrics may include probability of a dropped call, average response time based on categories of emergencies, average response time for a particular geographic region, and/or any relevant findings made from the processing of recorded data associated with the emergency response coordinator system.

Additionally, the emergency response coordinator system may correlate incident types, type of emergency, response by the standard user during the emergency, response from the one or more emergency contacts during the emergency and/or known causes of the emergency with different environmental, socioeconomic, locational, or any relevant factors that provide insights into health events and response times associated with population and/or geographic data (e.g., age, ethnicity, city/town/country/state). For example, the emergency response coordinator system may produce findings that indicate the average response time of emergency services is longer in areas with Medicaid/Medicare users compared to the average response times of emergency services in areas with private healthcare users. In another example, the emergency response coordinator system may indicate that more heart attacks occur within a specific region of a city based on the types of the emergencies in that specific region. These findings are useful evaluations of modern emergency response organizations and medicine in general, which can be useful for insurance companies, emergency response organizations, hospitals, and/or legislators. By way of example, FIG. 8F illustrates a centralized panel to retrieve these findings and is not limited to the presented options illustrated in FIG. 8F.
Aspect 1: A system for coordinating emergency services, comprising: a hardware device, wherein the hardware device comprises a first display and one or more physical mounting interfaces; and an electronic device communicatively coupled to the hardware device, wherein the electronic device comprises: a second display; and one or more processors, wherein the one or more processors are configured to: receive an input comprising a type of emergency; determine one or more emergency response organizations to contact based on the type of emergency; and establish communication between the electronic device and the one or more emergency response organizations.
Aspect 2: The system of claim 1, wherein the one or more processors are further configured to transmit user information to the one or more emergency response organizations.
Aspect 3: The system of claim 1, wherein the one or more processors are further configured to determine and present one or more media content items to present on the second display, wherein the one or more media content items are associated with the type of emergency.
Aspect 4: The system of claim 1, wherein the one or more processors are further configured to send one or more commands to the hardware device to modify the first display to indicate a location of the electronic device.
Aspect 5: The system of claim 1, wherein the one or more processors are further configured to, upon determining that the emergency contact communication is completed, generate response data associated with the input; and provide the response data to the one or more emergency response organizations.
Aspect 6: A method comprising: receiving a request for emergency services based on an emergency event associated with a user; determining a type of emergency based on the request; determining one or more emergency response organizations to communicate with based on the type of emergency; establishing communication with the one or more emergency response organizations; and transmitting user information to the one or more emergency response organizations.
Aspect 7: The method of claim 6, further comprising receiving an indication of a completed request from the one or more emergency response organizations.
Aspect 8: The method of claim 7, further comprising generating response data based on the request correlated with environmental data associated with the emergency event, the type of emergency, the one or more emergency response organizations, or any combination thereof.
Aspect 9: The method of claim 8, further comprising generating one or more reports based on the correlated data.
Aspect 10: The method of claim 9, further comprising presenting the one or more reports to the one or more emergency response organizations.
Aspect 11: An electronic device comprising: a display, one or more speaker modules, one or more lighting modules, a communication interface, memory circuitry, and one or more processors, wherein the one or more processors are configured to receive, via the communication interface, one or more commands representative of a type of emergency associated with a dwelling.
Aspect 12: The electronic device of claim 11, wherein the one or more processors are further configured to determine and present a set of notifications, including at least a display pattern, based on: the type of emergency, user information, or any combination thereof.
Aspect 13: The electronic device of claim 12, wherein the one or more processors are further configured to communicate, via the communication interface, with additional electronic devices disposed within a predetermined proximity to the electronic device, and wherein communicating comprises transmitting the set of notifications to the additional electronic devices within the predetermined proximity.
Aspect 14: The electronic device of claim 13, wherein the set of notifications further includes a lighting pattern.
Aspect 15: The electronic device of claim 14, wherein the one or more processors are further configured to send the lighting pattern to the one or more lighting modules.
Aspect 16: The electronic device of claim 12, wherein the one or more processors are further configured to send display pattern to the display.
Aspect 17: The electronic device of claim 12, wherein the set of notifications further includes a sound pattern.
Aspect 18: The electronic device of claim 17 wherein the one or more processors are further configured to send the sound pattern to the one or more speaker modules.
Aspect 19: The electronic device of claim 11, wherein the one or more lighting modules comprise a lighting device selected from the group consisting of: a projection light configured to emit a visible light pattern onto a surface proximate the dwelling, or a pin light comprising one or more high-intensity light-emitting diodes (LEDs) configured to emit a constant or flashing illumination pattern indicative of the emergency event.
Aspect 20: The electronic device of claim 11, wherein the electronic device comprises a power supply, an interactable emergency service interface, and one or more physical mounting interfaces.

1. A system for coordinating emergency services, comprising:
a hardware device, wherein the hardware device comprises a first display and one or more physical mounting interfaces; and
an electronic device communicatively coupled to the hardware device, wherein the electronic device comprises:
a second display; and
one or more processors, wherein the one or more processors are configured to:
receive an input comprising a type of emergency;
determine one or more emergency response organizations to contact based on the type of emergency; and
establish communication between the electronic device and the one or more emergency response organizations.

2. The system of claim 1, wherein the one or more processors are further configured to transmit user information to the one or more emergency response organizations.

3. The system of claim 1, wherein the one or more processors are further configured to determine and present one or more media content items to present on the second display, wherein the one or more media content items are associated with the type of emergency.

4. The system of claim 1, wherein the one or more processors are further configured to send one or more commands to the hardware device to modify the first display to indicate a location of the electronic device.

5. The system of claim 1, wherein the one or more processors are further configured to, upon determining that the emergency contact communication is completed, generate response data associated with the input; and provide the response data to the one or more emergency response organizations.

6. A method comprising:
receiving a request for emergency services based on an emergency event associated with a user;
determining a type of emergency based on the request;
determining one or more emergency response organizations to communicate with based on the type of emergency;
establishing communication with the one or more emergency response organizations; and
transmitting user information to the one or more emergency response organizations.

7. The method of claim 6, further comprising receiving an indication of a completed request from the one or more emergency response organizations.

8. The method of claim 7, further comprising generating response data based on the request correlated with environmental data associated with the emergency event, the type of emergency, the one or more emergency response organizations, or any combination thereof.

9. The method of claim 8, further comprising generating one or more reports based on the correlated data.

10. The method of claim 9, further comprising presenting the one or more reports to the one or more emergency response organizations.

11. An electronic device comprising:
a display, one or more speaker modules, one or more lighting modules, a communication interface, memory circuitry, and one or more processors, wherein the one or more processors are configured to receive, via the communication interface, one or more commands representative of a type of emergency associated with a dwelling.

12. The electronic device of claim 11, wherein the one or more processors are further configured to determine and present a set of notifications, including at least a display pattern, based on: the type of emergency, user information, or any combination thereof.

13. The electronic device of claim 12, wherein the one or more processors are further configured to communicate, via the communication interface, with additional electronic devices disposed within a predetermined proximity to the electronic device, and wherein communicating comprises transmitting the set of notifications to the additional electronic devices within the predetermined proximity.

14. The electronic device of claim 13, wherein the set of notifications further includes a lighting pattern.

15. The electronic device of claim 14, wherein the one or more processors are further configured to send the lighting pattern to the one or more lighting modules.

16. The electronic device of claim 12, wherein the one or more processors are further configured to send display pattern to the display.

17. The electronic device of claim 12, wherein the set of notifications further includes a sound pattern.

18. The electronic device of claim 17, wherein the one or more processors are further configured to send the sound pattern to the one or more speaker modules.

19. The electronic device of claim 11, wherein the one or more lighting modules comprise a lighting device selected from the group consisting of:
a projection light configured to emit a visible light pattern onto a surface proximate the dwelling, or
a pin light comprising one or more high-intensity light-emitting diodes (LEDs) configured to emit a constant or flashing illumination pattern indicative of the emergency event.

20. The electronic device of claim 11, wherein the electronic device comprises a power supply, an interactable emergency service interface, and one or more physical mounting interfaces.
